(19) United States
(12) Patent Application Publication
(10) Pub. No.: US 2004/0014018 A1
(43) Pub. Date: Jan. 22, 2004

(54) Multimedia system for human sensory education and assessment

(76) Inventor: David M. Davis, Spring Mount, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/417,988

(22) Filed: Apr. 17, 2003

Related U.S. Application Data
(60) Provisional application No. 60/374,250, filed on Apr. 19, 2002.

(51) Int. Cl. G09B 3/00

(52) U.S. Cl. 434/322; 434/350; 434/362; 434/236

(57) ABSTRACT

Multimedia systems and methods for human sensory education and assessment are disclosed. A system according to the invention may include an administrative sub-system, which may be a local or remote server, and a delivery device, which may be a local, micro-processor-based device, such as a PC, PDA, telephone, or the like. The delivery device may include one or more optional add-on devices that simulate a sense or provide enhanced sensory capabilities. The administrative sub-system may include a data store that may contain, for example: one or more respective content modules and test batteries associated with each of the human senses; assessment results and other information relating to the senses, users of the system, test subjects, etc.; and a list of employees, students, or other users that can be given access to the stored information. An administrator can dynamically create/customize, and download to the delivery device, one or more computer files that may include, for example, an extracted subset of information about the ensuing user's demographics, curriculum of selectable education modules, history of previously reviewed modules, previous assessment results, and other information the delivery device can access to pre-load information for the anticipated user session. The delivery device configures the downloaded modules to enable a user to study the educational modules and perform sensory tests and assessments as provided in the downloaded file, and provides results data to the administrative sub-system, which stores the results data for later retrieval and reporting by authorized persons.

### CROSS-REFERENCE TO RELATED APPLICATIONS

This application claims priority from Provisional U.S. Patent Application No. 60/374,250, filed Apr. 19, 2002, the contents of which are hereby incorporated by reference.

### FIELD OF THE INVENTION

The invention relates to software and hardware-assisted systems that provide educational content, simulation of certain human sensory conditions, and a personal assessment of one or more of a plurality of human sensory systems.

### BACKGROUND OF THE INVENTION

Understanding and assessment of a current state of performance of human senses is interesting for a variety of applications including, but not limited to, occupational health and safety, acute care, management of specific disease states and conditions, validating efficacy of medications and nutritional supplements, and general health and wellness monitoring. To the best of the inventor's knowledge, no common framework and system previously existed that would provide a simple, efficient, flexible, and modular delivery platform for content, simulation, and assessment of a plurality of human senses.

### SUMMARY OF THE INVENTION

The invention provides a way to flexibly structure content, sensory assessment, and simulation of certain common conditions or diseases that affect the human sensory systems. Each of the human senses—vision, hearing, smell, taste, and touch—can be embodied in this invention through various multimedia capabilities. Informational content about each of the sensory systems, including its anatomical design and functions, common conditions and diseases, and research trends and recent discoveries, can be provided as a simple means to educate the user on that particular sensory system.

### BRIEF DESCRIPTION OF THE DRAWINGS

Other features of the present invention are further apparent from the following detailed description of the embodiments of the present invention taken in conjunction with the accompanying drawing, of which:

FIG. 1 is a flowchart of a preferred embodiment of an administrative sub-system according to the invention;

FIG. 2 depicts a preferred embodiment of a delivery sub-system according to the invention; and

FIG. 3 depicts a preferred embodiment of an administrative update sub-system according to the invention.

### DETAILED DESCRIPTION OF ILLUSTRATIVE EMBODIMENTS

A system according to the invention can include a local delivery sub-system and a local or remote administrative sub-system. The delivery sub-system can be used in conjunction with any of a variety of microprocessor-based systems. In certain instances, such as smell and touch, for example, an add-on device may be employed to facilitate sensory simulation or assessment characteristics.

In a preferred embodiment, the administrative sub-system may be a tabular or database system that contains or references a variety of content modules, results from previous sensory assessment sessions, and/or a master file of users of the system, such as employees, students, or other users that can be given access to the stored information.

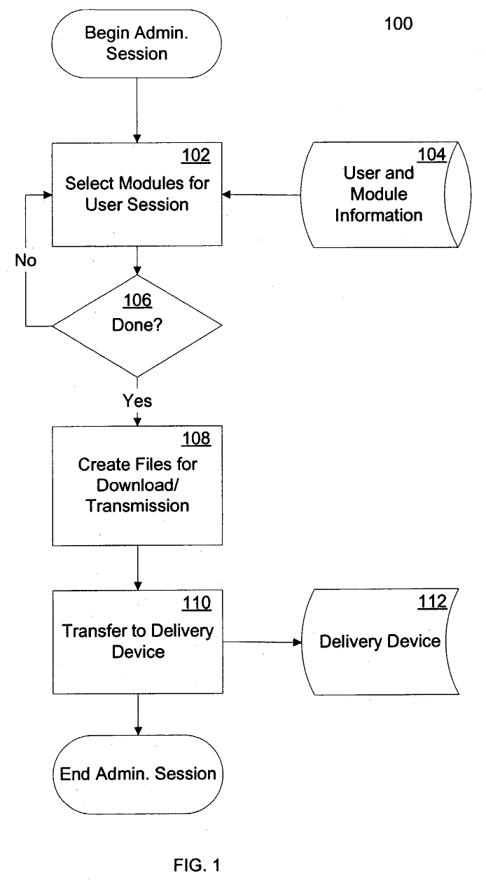

FIG. 1 provides a flowchart 100 of a preferred embodiment of an administrative sub-system according to the invention. At step 102, an Administrator or end-user can access the administrative sub-system, by logging into a website, for example, and choosing a set of modules from data store 104 to be viewed and completed by an ensuing user. These modules may include a plurality of types of information, including educational content, simulations that are multimedia examples of diseases and conditions that can affect the sensory system(s), user demographic information, previous test results, and parameters that determine which modules will be conveyed as well as their format and presentation, among others. Data store 104 can be a database, or a series of otherwise indexed files and links to source content modules that may include educational content, simulations that are multimedia examples of diseases and conditions that can affect the sensory system(s), user demographic and identification information, previous test results, and parameters that determine which modules will be conveyed as well as their format and presentation, among others. According to decision test (step 106), the Administrator may select multiple modules from a plurality of locations and types, and continue in this activity until they have completed their selection of all necessary or elective modules.

In step 108, the selected files and modules are packaged into a format suitable for download or other type of conveyance to the delivery device. This may or may not include encryption of some or all of the content. Once the files have been suitably packaged for transmission to the delivery device, they are conveyed to the device in step 110. This may be by a download and installation routine, by attachment and transmission through a network such as the Internet or Intranet, or any other means of conveying the computer readable files for subsequent updating of the information on the delivery device. The delivery device 112 may be any of a plurality of microprocessor-based devices, including a Personal Computer, Personal Digital Assistant, Internet Appliance, CD or DVD player, phone (e.g., cellular phone, wireless phone, etc.), and other similarly capable devices that can read and render the capabilities described by the content files. From the administrative sub-system, the Administrator or user can also select previous iterations of an assessment performed by a user, and download or otherwise transfer that information to the delivery device for comparative purposes. This and the user's identity information are established on the delivery device, and the user may then be given or otherwise provided the delivery device, and instructed on how and when to complete their review.

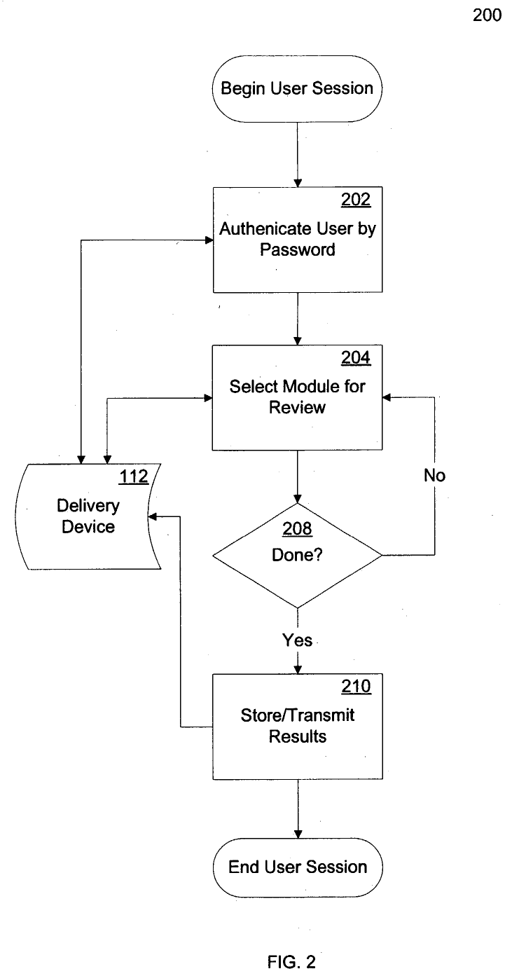

FIG. 2 provides a flowchart 200 of a preferred embodiment of the user delivery sub-system according to the invention. In step 202, the user must authenticate their identity in order to access the information that has been provided for them to review and complete. This authentication may be accomplished by correct specification of a user name and password combination for instance, that can be matched to the user's identification information that is embedded in the content module(s) or user demographic information. Once the user has successfully completed the authentication process, they may access the content and modules in step 204 that have been placed on the delivery device 112 for their review and completion. This may include any of a plurality of types of information, including educational content, simulations that are multimedia examples of diseases and conditions that can affect the sensory system(s), user demographic information, previous test results, and parameters that determine which modules will be conveyed as well as their format and presentation, among others.

Content and information modules such as those described in the following list can be created or assembled from various publicly available sources of health information, or licensed from authors for use in building specially designed and formatted modules for delivery in concert with the screening test battery and other information. Examples of the various content and information modules include:

Animated or still image examples and text description of the anatomical workings of the sensory system, including specific structures, function, and interface with other related organs.

Text and animated or still image reference information on common problems, conditions, and diseases of this sensory system, including generally accepted remedies and therapeutic aids. In certain cases where applicable, an example of a deficiency or limiting condition may be provided by use of multimedia capabilities of the device.

Text, still or animated images, sound and video clips and other such multimedia presentation of emerging trends and recent scientific advances related to this human sensory system

Interesting facts or trivia related to this sensory system presented either in a text readable or interactive fashion, such as a quiz or survey.

The user can observe modules that they have not yet completed. Preferably, the system automatically annotates “complete” or “incomplete” for each module displayed.

The screening or assessment section of each sensory system may include an interview or history question/answer battery designed to illicit problem areas in routine use of the sensory system in question. These questions can be structured as Yes/No or a list of descriptive choices that enable the user to quickly review and respond. The questions and answers may also carry a warning or risk level indicator such as a 1-10 value where 1 represents little or no risk, and 10 represents significant risk. The cumulative score can then be determined and given an overall risk rating by range, whereby a low overall score would represent relatively normal sensory function, and a high score would represent a significant overall impairment of the sense being tested. Those with a moderate to high overall score would receive a recommendation to seek further testing and care by a healthcare professional, as well as specific information as to which questions indicated above normal risk factors.

The remaining portion of the test battery for each of the sensory systems include a series of tests that are intended to perform various exercises and methods of sensory presentation that help identify an impairment or deficiency condition in the sense being tested. In general, while each of these sensory test methods may require different technological means to produce the sample for the user to respond to, each can be readily quantified according to sensory perception, and therefore has an associated relative right and wrong answer. Just as in the Interview portion of the test battery, the correct or weighted values together form a composite score that can either be indicative of a normal sensory response pattern, or one that indicates the possibility of dysfunction.

The following test batteries may be used in connection with the systems and methods of the invention. It should be understood that the test batteries described herein are exemplary, and in no way should be considered limiting of the invention.

Vision—a series of exercises intended to test for various indicators of visual function, including visual acuity, muscle balance, stereopsis, and visual field can be presented. Computer-based vision testing programs are well known, and can be adapted for use in connection with the inventive systems and methods. Some of these testing methods may require additional accessories, such as red/green glasses for testing stereovision.

Hearing—a test comprised of a series of sine wave tones at varying frequency (typically at specific intervals between 125 Hz and 16 KHz, such as 250 Hz, 500 Hz, 1 KHz, 2 KHz, 3 KHz, 4 KHz, 6 KHz, and 8 KHz) can be presented for each ear, with a user-adjustable volume (decibel level) to establish the minimum threshold setting for the user at each frequency. An audiogram can then be presented for enumerating the user's hearing levels at the various frequencies tested. Additional tests for audible sounds and speech, and bone conduction of the sine wave tones may be provided.

Smell and Taste—through the use of prior art olfactory and gustatory testing methods in conjunction with the basic delivery device, a series of smells and/or tastes can be provided to the user to test sensory function. These scent and taste rendering methods can be provided via a “peel and sniff” booklet and taste-strip means respectively, for example. For scent rendering, hardware devices are known that dispense a scent or a combination of scents from cartridges in a pattern and time sequence that is dictated by computer instructions. Strength or ranking of the scent or taste on a rating scale may be requested in addition to basic detection testing.

Touch—a series of hardware-assisted exercises to assess range of motion, touch sensation, and motor skills can be simulated via currently available haptic technology. Both vibration and g-force simulation can be accomplished with standard computer accessories such as a mouse, or with more specialized devices and couplers that can be purchased or in certain cases may be fabricated in order to apply the forces to the part of the body being tested.

Within each content module or section reviewed by the user in 204, they may receive feedback and recommendations as to why their risk is elevated compared to normal responses or values within an assessment module. This feedback may be either specific to a question or test, or cumulative based on the entirety of the information reviewed and testing completed to that point in their review. Structured reporting of the assessment results, recapping their performance in tests and recommendations to visit a healthcare professional may be provided if warranted by their answers/results and scoring.

If, in step 208, it is determined that no more test batteries remain, in step 210, their results and inventory of tests performed, modules reviewed, and any other data collected during the user session are saved on the delivery device 112, in preparation for subsequent aggregation and reporting. This is typically done by saving a results and log file on the delivery device, but can also be accomplished by a direct interface and transfer to the administrative sub-system when connection and data transfer can be accommodated directly via a network connection or other similar means.

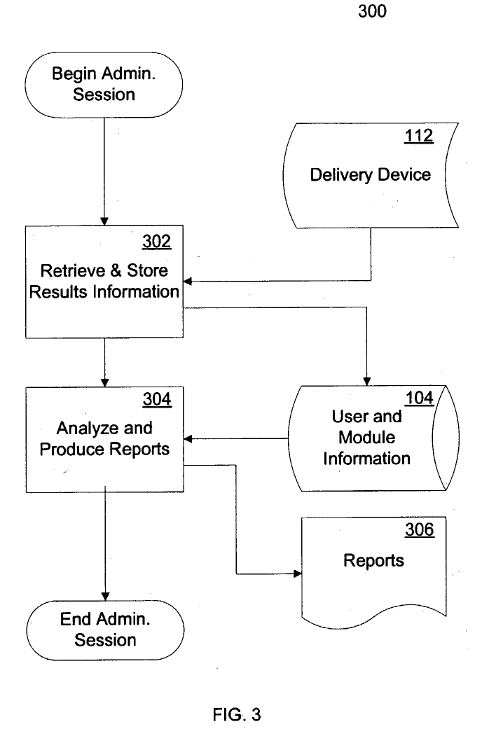

FIG. 3 provides a flowchart 300 of a preferred embodiment of the return, storage, and reporting of the user results and information to the administrative sub-system according to the invention. At step 302, the delivery device 112 establishes communication with or otherwise forwards the information gathered in a store-and-forward fashion to the administrative sub-system for permanent storage in 104. All data collected on the user's content reviewed, tests performed, and other relevant data are updated into the data store 104, including time and date information for audit purposes. Step 304 provides the ability to retrieve and review prior session results for comparative analysis for trends and shifts in sensory performance over time, and optionally produces reports at step 306.

Thus, there have been described multimedia systems and methods for human sensory education and assessment. Those skilled in the art will appreciate that numerous changes and modifications can be made to the preferred embodiments of the invention, and that such changes and modifications can be made without departing from the spirit of the invention.

What is claimed:

1. A system for assessment of human senses, the system comprising:
an administrative sub-system and a delivery device,
wherein the administrative sub-system downloads to the delivery device one or more respective content modules associated with one or more human senses, and
wherein the delivery device configures the downloaded content modules to enable a user to study educational modules and perform sensory tests and assessments, and provides results data to the administrative sub-system for storage, reporting, and later retrieval by authorized persons.

2. The system of claim 1, wherein at least one of the content modules is associated with vision.

3. The system of claim 2, wherein the sensory tests include a series of exercises intended to test for at least one of visual acuity, muscle balance, stereopsis, and visual field.

4. The system of claim 1, wherein at least one of the content modules is associated with hearing.

5. The system of claim 4, wherein the sensory tests include a test comprising a series of sine wave tones at various frequencies.

6. The system of claim 5, wherein the results include an audiogram that enumerates the user's hearing levels at the various frequencies.

7. The system of claim 1, wherein at least one of the content modules is associated with smell.

8. The system of claim 7, wherein the sensory tests include a series of scents that can be provided to the user.

9. The system of claim 8, wherein the sensory tests include strength or ranking of the scents.

10. The system of claim 1, wherein at least one of the content modules is associated with taste.

11. The system of claim 10, wherein the sensory tests include a series of tastes that can be provided to the user.

12. The system of claim 11, wherein the sensory tests include strength or ranking of the tastes.

13. The system of claim 1, wherein at least one of the content modules is associated with touch.

14. The system of claim 13, wherein the sensory tests include a series of exercises to assess at least one of range of motion, touch sensation, and motor skills.

15. A system for assessment of human senses, the system comprising:
a delivery device that receives one or more respective modules associated with one or more human senses, and configures the received modules to enable a user to perform sensory tests and assessments associated with the one or more human senses.

16. The system of claim 15, wherein the delivery device receives one or more respective content modules associated with one or more human senses, configures the received content modules to enable the user to review educational material associated with the one or more senses.

17. The system of claim 16, wherein the delivery device provides results data to an administrative sub-system.

18. The system of claim 15, wherein the delivery device is a microprocessor-based device.

19. The system of claim 15, wherein the delivery device is one of a phone, personal computer, and personal digital assistant.

20. The system of claim 15, wherein the delivery device includes one or more add-on devices, each of which is adapted to simulate at least one of the human senses.

21. The system of claim 15, wherein the delivery device includes one or more add-on devices, each of which is adapted to provide an enhanced sensory capability.

22. A system for assessment of human senses, the system comprising:
an administrative sub-system that provides to a delivery device one or more respective content modules associated with one or more human senses,
wherein an administrator can access the administrative sub-system and dynamically customize one or more computer files that includes information the delivery device can access to pre-load information for an anticipated user session.

23. The system of claim 22, wherein the administrative sub-system receives results data from the delivery device and stores the results data for later retrieval.

24. The system of claim 22, wherein the administrative sub-system includes a data store that contains the one or more respective content modules associated with one or more of the human senses, assessment results relating to the senses, and a list of users that can be given access to the stored information.

25. The system of claim 22, wherein the information includes at least one of an extracted subset of information about a selected user's demographics, curriculum of selectable education modules, history of previously reviewed modules, and previous test and assessment results.

26. A method for assessment of human senses, the method comprising:
receiving from an administrative sub-system, one or more content modules, each of which is associated with at least one of the human senses;
configuring the downloaded modules to enable a user to study the educational modules and perform sensory assessments; and
providing results data to the administrative sub-system for storage and later retrieval by authorized persons.
